(19) United States
(12) Patent Application Publication
(10) Pub. No.: US 2025/0199246 A1
(43) Pub. Date: Jun. 19, 2025

(54) SYSTEMS AND METHODS FOR VIBRATION DAMPING IN MULTI-FIBER CONNECTORS

(71) Applicant: Smiths Interconnect Canada Inc., Kirkland (CA)

(72) Inventors: Hervé Lavoie, MontRoyal (CA); Eric Wider, Palm City, FL (US); Gabriel Monette, Montreal (CA); Thomas Ducellier, Ottawa (CA)

(21) Appl. No.: 18/985,187

(22) Filed: Dec. 18, 2024

Related U.S. Application Data
(60) Provisional application No. 63/634,990, filed on Apr. 17, 2024.
(60) Provisional application No. 63/611,832, filed on Dec. 19, 2023.

(51) Int. Cl. G02B 6/36

(52) U.S. Cl. CPC G02B 6/3616

(57) ABSTRACT

Systems and methods of a lid for use with an optical connector are provided. The lid includes a body, and at least one cord segment positioned within the body, wherein the at least one cord segment is configured to contact the optical connector and damp vibrations experienced by the optical connector when the optical connector is positioned within the body.

### CROSS-REFERENCE TO RELATED APPLICATIONS

This patent application claims priority to U.S. Provisional Patent Application No. 63/611,832, filed Dec. 19, 2023, and U.S. Provisional Patent Application No. 63/634,990, filed Apr. 17, 2024, the disclosures of which are hereby incorporated by reference herein in their entirety as part of the present application.

### BACKGROUND

The embodiments described herein relate generally to multi-fiber connectors and, more particularly, to multi-fiber connectors that facilitate vibration damping.

Mechanical transfer (MT) optical connectors are high-density, high performance fiber optic connectors. Such connectors are designed for ease of use, generally requiring no special equipment or extensive training to connect. Vibrations experienced by an MT connector may cause physical and/or mechanical damage to the connector (e.g., wear, fretting, and/or cracks on the optical interface), which may result in degradation of optical signals transmitted through the connector, impacting data transmission quality.

Accordingly, vibration testing is a crucial aspect of assessing the performance of MT optical connectors, particularly when the connectors will be used in relatively harsh environments (e.g., satellite launches, aerospace applications, and/or military applications). Vibration levels for testing are typically determined based on the expected conditions the MT connector will face in its intended application.

For some applications, vibration testing of fiber optic cables and assemblies may be performed at levels greater than a root mean square acceleration of 20.0 g (i.e., Gᵣₘₛ of 20.0). However, for more rigorous applications (e.g., satellite launches, aerospace applications, and/or military applications), vibration testing may be performed at levels up to 60.0 Gᵣₘₛ. Accordingly, it would be desirable to provide connector assemblies that are able to operate properly and reliably at relatively high vibration testing levels.

### BRIEF DESCRIPTION

In one aspect, a lid for use with an optical connector is provided. The lid includes a body, and at least one cord segment positioned within the body, wherein the at least one cord segment is configured to contact the optical connector and damp vibrations experienced by the optical connector when the optical connector is positioned within the body.

In another aspect, a connector assembly is provided. The connector assembly includes a lid for use with an optical connector. The lid includes a body, and at least one cord segment positioned within the body, wherein the at least one cord segment is configured to contact the optical connector and damp vibrations experienced by the optical connector when the optical connector is positioned within the body. The connector assembly further includes a tool operable to assist in attaching the lid to the optical connector.

In yet another aspect, a method of securing a connection between a first optical connector and a second optical connector is provided. The method includes attaching a tool to a lid, the lid including a body and at least one cord segment positioned within the body, connecting the first optical connector to the second optical connector, and positioning, using the tool, the lid onto the first optical connector such that the at least one cord segment contacts the optical connector and damps vibrations experienced by the optical connector.

### BRIEF DESCRIPTION OF THE DRAWINGS

FIG. 1 is a perspective view of one embodiment of a first MT connector and a second MT connector.

FIG. 2A is a perspective view of one embodiment of a lid that may be used to damp vibrations experienced by MT connectors.

FIG. 2B is an exploded perspective view of the lid shown in FIG. 2A.

FIG. 2C is a top view of the lid shown in FIG. 2A.

FIG. 3A illustrates a transceiver module with an optical connector.

FIGS. 3B and 3C illustrate connections between a first optical connector and a second optical connector.

FIGS. 3D-3F illustrate one embodiment of using the lid shown in FIGS. 2A-C to damp vibrations experienced at an interface between a first MT connector and a second MT connector.

FIG. 4 is a cross-sectional view of portions of a transceiver, lid, and first and second MT connectors.

FIG. 5 is a perspective view of another embodiment of a connection between a first MT connector and a second MT connector.

FIG. 6A is a perspective view of one embodiment of a tool that may be used to assist in attached a lid to an MT connector.

FIG. 6B is a bottom view of the tool shown in FIG. 6A.

FIG. 7 is a bottom view of one embodiment of a connection between a first MT connected and a second MT connector that uses a lid and a tool.

FIGS. 8A-8L illustrate one embodiment of using a tool and a lid to make and stabilize a connection between first and second MT connectors.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, is not to be limited to the precise value specified. In at least some instances, the approximating language may correspond to the precision of an instrument for measuring the value. Here and throughout the specification and claims, range limitations are combined and interchanged, such ranges are identified and include all the sub-ranges contained therein unless context or language indicates otherwise.

The present disclosure provides a new compact connector assembly for an MT-to-MT connection, designed to withstand relatively high vibration levels (e.g., vibration levels of at least 28 Gᵣₘₛ, more particularly vibration levels of at least 45 Gᵣₘₛ, and even more particularly vibration levels of at least 60 Gᵣₘₛ). The connector assembly is engineered to maintain MT optical interface integrity and to ensure reliable data transmission under extreme environmental conditions. As described herein, vibration damping within the connector assembly is achieved through the use of at least one deformable cord segment. The deformable cord segment satisfies outgassing requirements for space applications.

For example, the embodiments described herein provide a lid for use with an optical connector. The lid includes a body, and at least one cord segment positioned within the body, wherein the at least one cord segment is configured to contact the optical connector and damp vibrations experienced by the optical connector when the optical connector is positioned within the body.

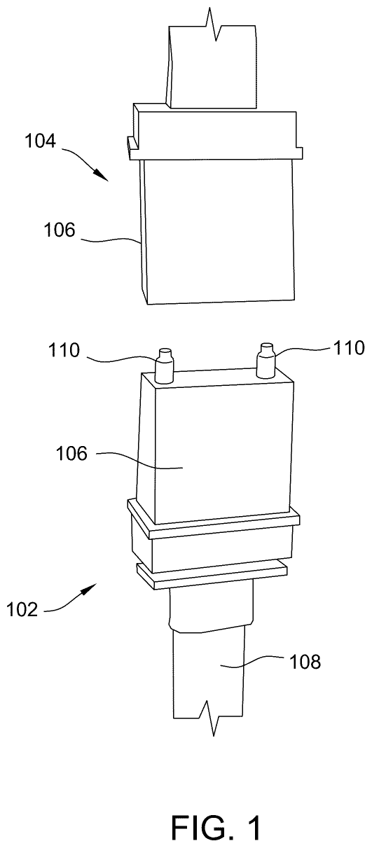

FIG. 1 is a perspective view of a first MT connector 102 and a second MT connector 104 (broadly, optical connectors). Each MT connector 102 and 104, includes a ferrule 106 holding a plurality of fiber optic cables 108 (e.g., eight, twelve, or twenty-four fiber optic cables 108). MT connectors 102 and 104 mate with one another to form a connection between fiber optic cables 108 in each ferrule 106, facilitating data transmission through fiber optic cables 108. In this embodiment, first MT connector 102 includes two dowels 110 sized and oriented to fit within corresponding recesses (not shown) defined within second MT connector 104. Dowels 110 facilitate proper alignment of first and second MT connectors 102 and 104 during mating.

Notably, when first and second MT connectors 102 and 104 are subject to vibrations (e.g., due to the operating environment in which first and second MT connectors 102 and 104 are implemented), such vibrations may damage first and second MT connectors 102 and 104 and/or cause first and second MT connectors 102 and 104 to disengage from one another, disrupting data transmission through fiber optic cables 108. Accordingly, it is desirable to prevent vibrations from impacting operation of first and second MT connectors 102 and 104.

At least some known connector assemblies use a spring clip to damp vibrations experienced by MT connectors, such as first and second MT connectors 102 and 104. Such spring clips may withstand vibration levels of up to, for example 20 Gᵣₘₛ. However, such spring clips insufficiently damp higher levels of vibration (e.g., levels of over 28 Gᵣₘₛ). Further, a ferrule of an MT connector typically needs to be modified (e.g., by machining the ferrule to define multiple notches) for use with the spring clip. This modification adds labor and costs, induces stress to the ferrule, and weakens the structural integrity of the ferrule due to loss of material. Further, at high levels of vibration, the ends of fibers within the ferrule may develop severe fretting when coupled with the spring clip, and weakened machined areas of the ferrule may develop stress cracks. Accordingly, spring clips are generally insufficient for vibration damping applications at higher vibration levels (e.g., satellite launches, aerospace applications, and/or military applications). In contrast, the connector assemblies disclosed herein have improved functionality and reliability relative to such spring clips.

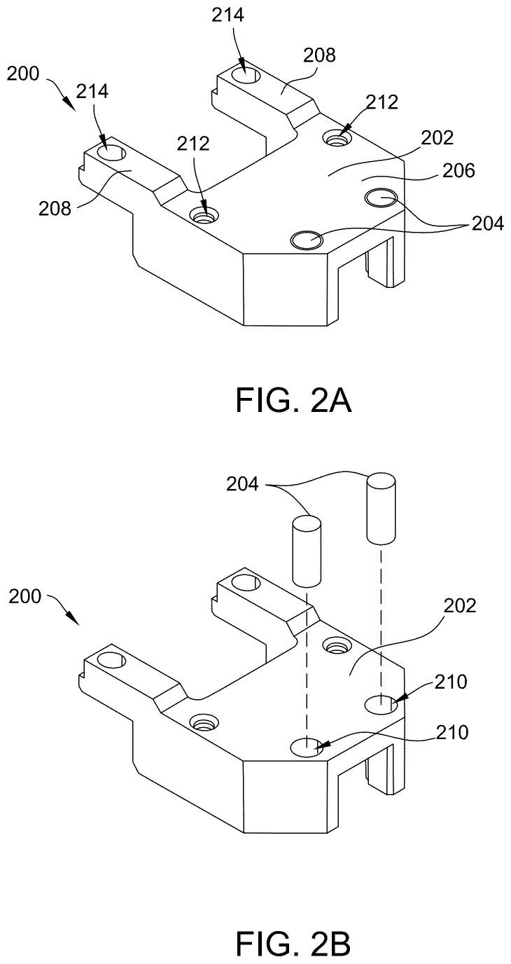

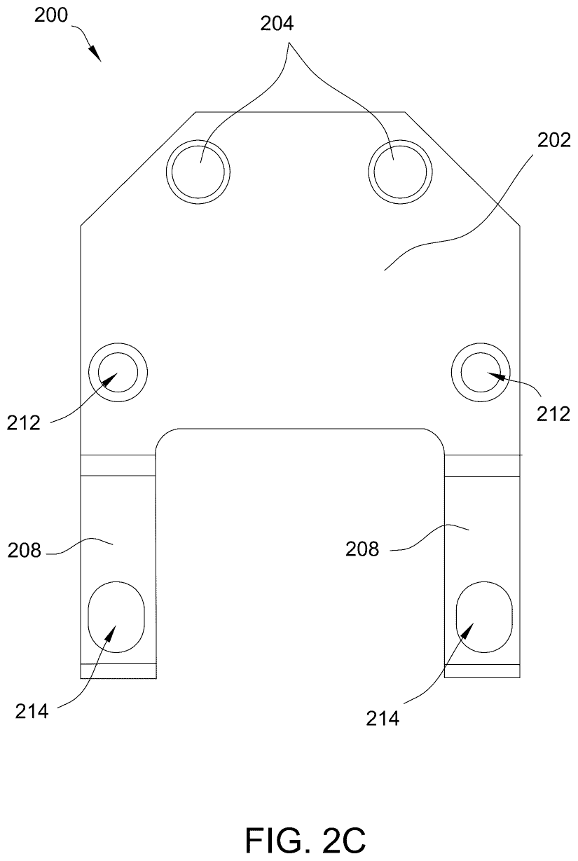

FIG. 2A is a perspective view of one embodiment of a lid 200 that may be used to damp vibrations experienced by MT connectors. FIG. 2B is an exploded perspective view of lid 200, and FIG. 2C is a top view of lid 200. As shown in FIG. 2A, lid 200 includes a body 202 and a plurality of cord segments 204. Body 202 includes a base 206 and two arms 208 extending from base 206.

First apertures 210 and second apertures 212 extend through base 206. Further, a third aperture 214 extends through each arm 208. In this embodiment, each cord segment 204 is positioned within a corresponding first aperture 210. Further, a cross section of each first aperture 210 is substantially circular. As shown in FIG. 2C, however, third apertures 214 have a cross section with an oblong or elliptical shape. This accommodates tolerance variations between lid 200 and other components during use of lid 200, as described herein.

In the example embodiment, body 202 is metal (e.g., aluminum) and cord segments 204 are made of a deformable material (e.g., rubber silicone). Alternatively, body 202 and cord segments 204 may be made of any suitable material.

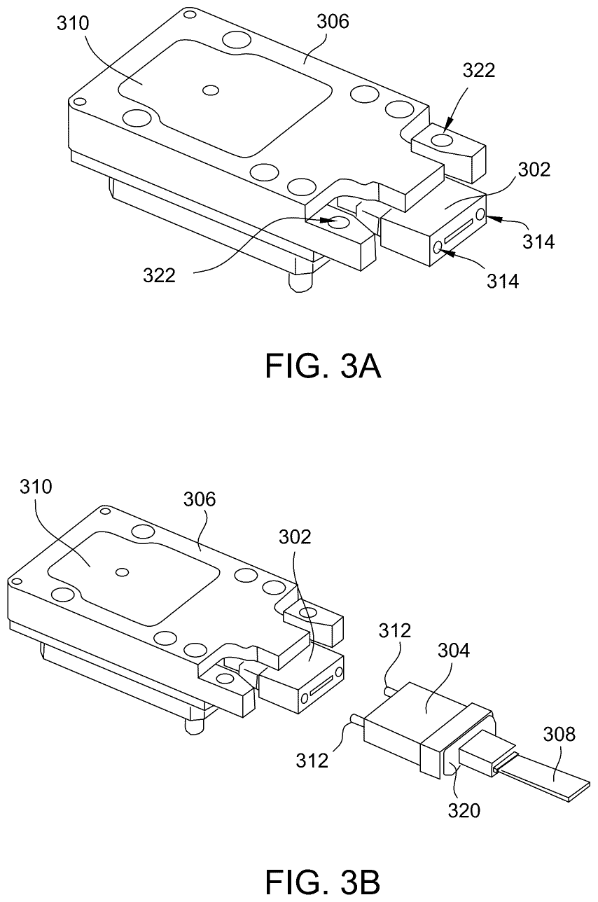

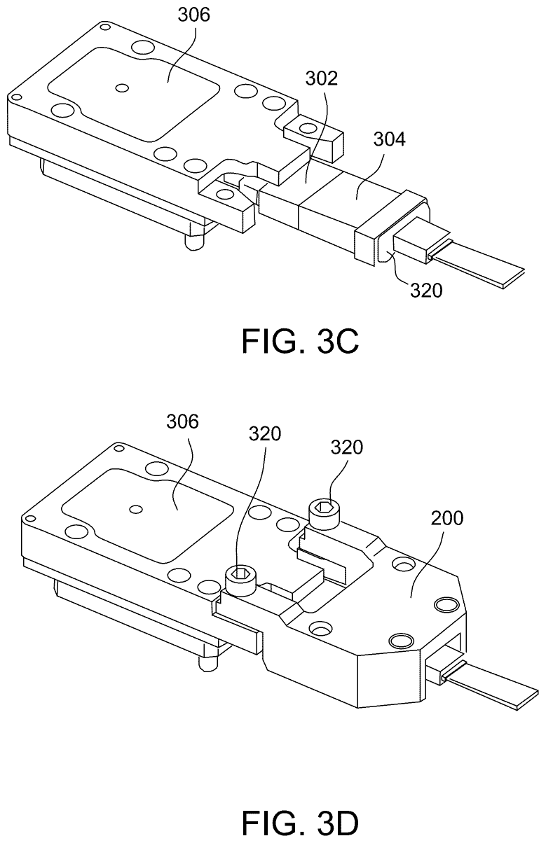

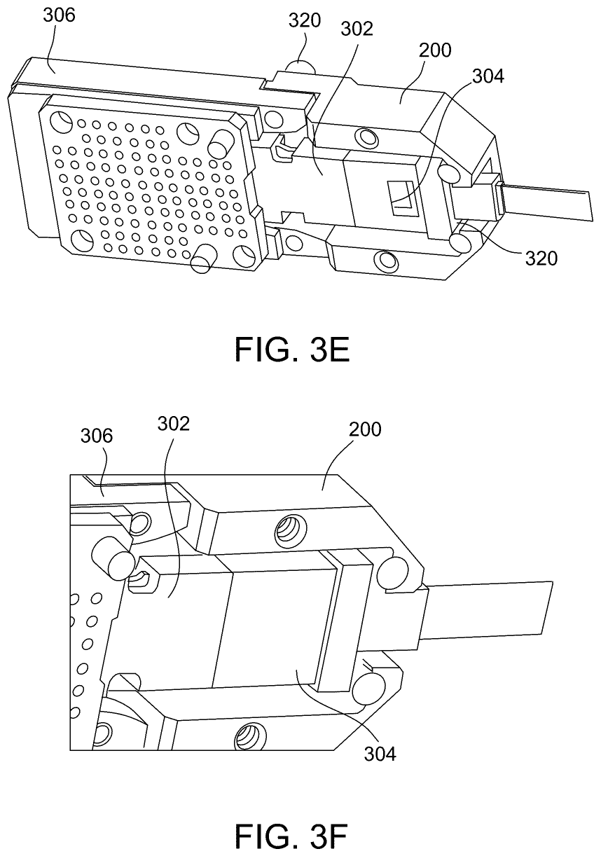

Lid 200 facilitates damping vibrations experienced by MT connectors. For example, FIGS. 3A-3F illustrate using lid 200 to damp vibrations experienced at an interface between a first MT connector 302 and a second MT connector 304. In this embodiment, first MT connector 302 is included on a transceiver 306, and second MT connector 304 is included on a cable 308. Alternatively, first and second MT connectors 302 and 304 may be included on any suitable components or devices.

FIG. 3A shows transceiver 306 including first MT connector 302. Transceiver 306 includes a housing 310. FIG. 3B shows second MT connector 304 aligned with first MT connector 302, but not yet engaged with first MT connector 302. In FIG. 3B, dowels 312 are shown extending from second MT connector 304. To facilitate aligning first and second connector 302 and 304, dowels 312 are sized and oriented to engage corresponding recesses 314 defined in first connector 302. In FIG. 3C, first MT connector 302 is mated with second connector 304.

As shown in FIGS. 3D-3F, lid 200 is configured to engage transceiver 306 and second connector 304. When lid 200 engages transceiver 306 and second MT connector 304, lid 200 facilitates damping vibrations experienced by first and second MT connectors 302 and 304. Specifically, in this embodiment, fasteners 320 extend through third apertures 214 and engage corresponding apertures 322 defined in housing 310 to couple lid 200 to transceiver 306. As noted above, third apertures 214 have a cross section with an oblong or elliptical shape. This assists in accommodating tolerance variations between lid 200 and housing 310.

As shown in FIGS. 3E and 3F, with lid 200 positioned on second MT connector 304, cord segments 204 contact and compress against a rear surface 320 of second MT connector 304. More specifically, as described in detail herein, cord segments 204 at least partially deform and bulge to press against rear surface 320 and other portions of second MT connector 304 to secure the position of second MT connector 304, which facilitates damping vibrations. For example, cord segments 204 may have a compression force in a range from approximately 5 to 15 Newtons, across a range of temperatures.

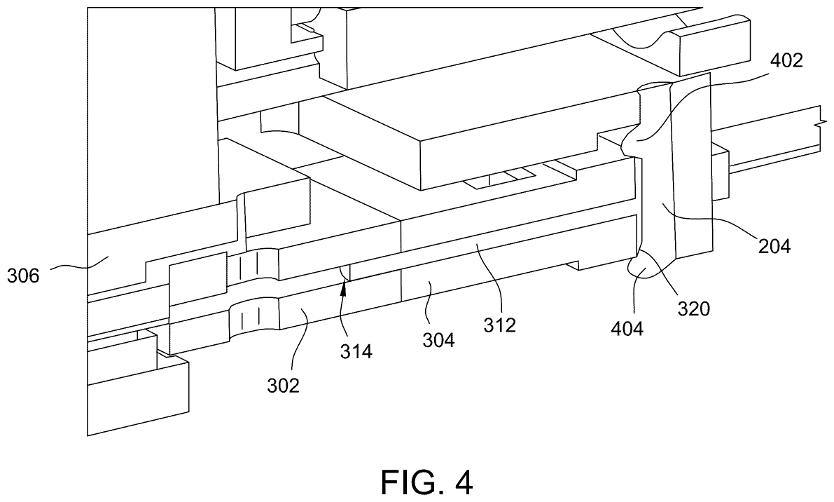

FIG. 4 is a cross-sectional view of portions of transceiver 306, lid 200, and first and second MT connectors 302 and 304. FIG. 4 shows dowel 312 positioned within recess 314. Further, FIG. 4 shows deformation of cord segment 204 around second MT connector 304. Specifically, with cord segment 204 compressed against rear surface 320, a first bulge 402 forms above second MT connector 304, and a second bulge 404 forms below second MT connector 304. These bulges 402 and 404 facilitate securing the position of second MT connector 304 and damping vibrations during operation.

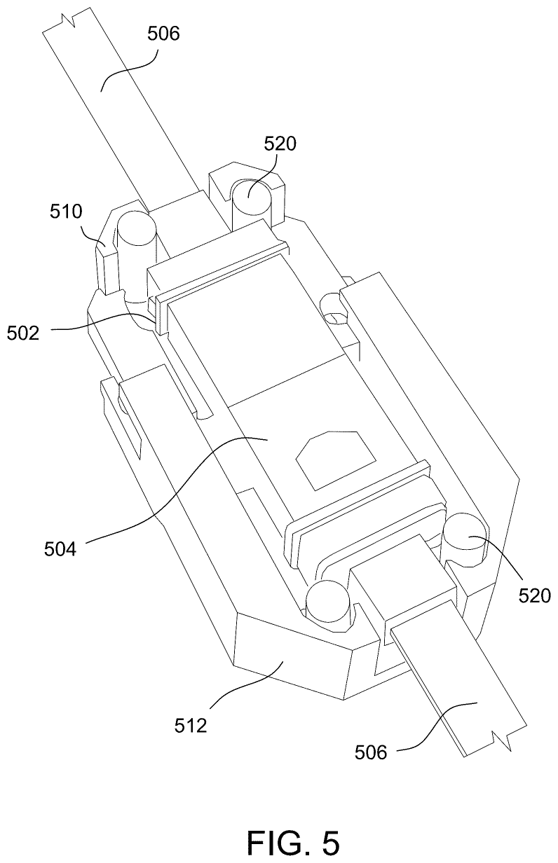

FIG. 5 is a perspective view of another embodiment of a connection between a first MT connector 502 and a second MT connector 504. In this embodiment, each MT connector 502 and 504 is included on a respective cable 506. Further, in this embodiment, a first lid 510 is positioned on first MT connector 502, and a second lid 512 is positioned on second MT connector 504 Lids 510 and 512 may be coupled to one another using any suitable coupling mechanism (e.g., fasteners). Further, each lid 510 and 512 includes cord segments 520 that operate substantially similar to cord segments 204 (shown in FIGS. 2A-4) to facilitate damping vibrations experienced by first and second MT connectors 502 and 504.

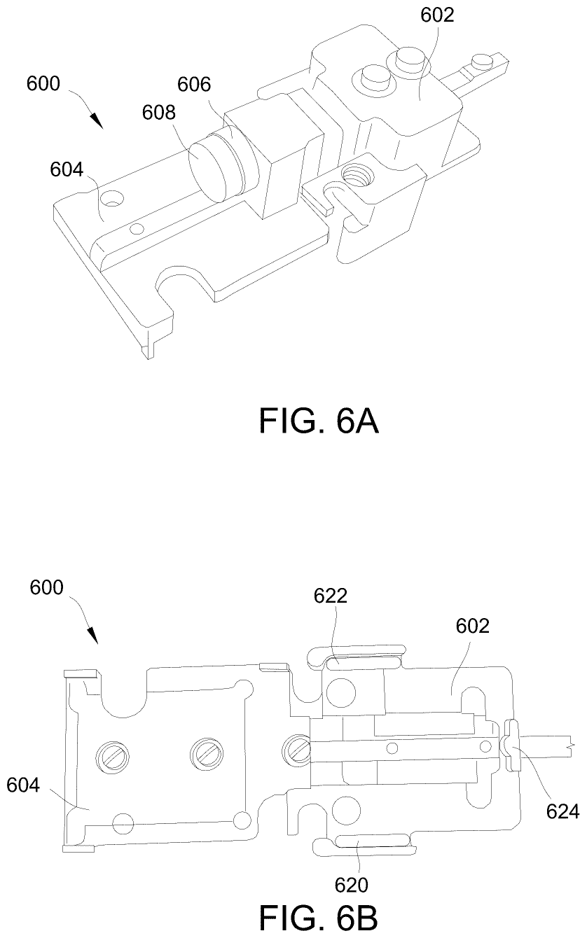

In some embodiments, a specialized tool is used to assist in attaching a lid (e.g., lids 200, 510, and 512) to an MT connector (e.g., MT connectors 302, 304, 502, and 504). FIG. 6A is a perspective view of one embodiment of such a tool 600, and FIG. 6B is a bottom view of tool 600.

As shown in FIGS. 6A and 6B, tool 600 includes a first component 602, a second component 604, and an adjustment mechanism 606 operable to adjust a relative position of first and second components 602 and 604. Adjustment mechanism 606 may include, for example, a screw mechanism 608 that is adjustable using, for example, a torque-limited screwdriver. As shown best in FIG. 6B, first component 602 includes a first contact surface 620, a second contact surface 622, and a third contact surface 624. Contact surfaces 620, 622, and 624 are sized and oriented to each contact a lid when tool 600 is applied to the lid, securing a position of the lid relative to tool 600. Because tool 600 contacts the lid in three locations, tool 600 may referred to as a tri-pivot tool. First and second contact surfaces 620 and 622 may be, for example, mats made of a microcellular urethane foam (e.g., Poron) and/or silicone tubing segments.

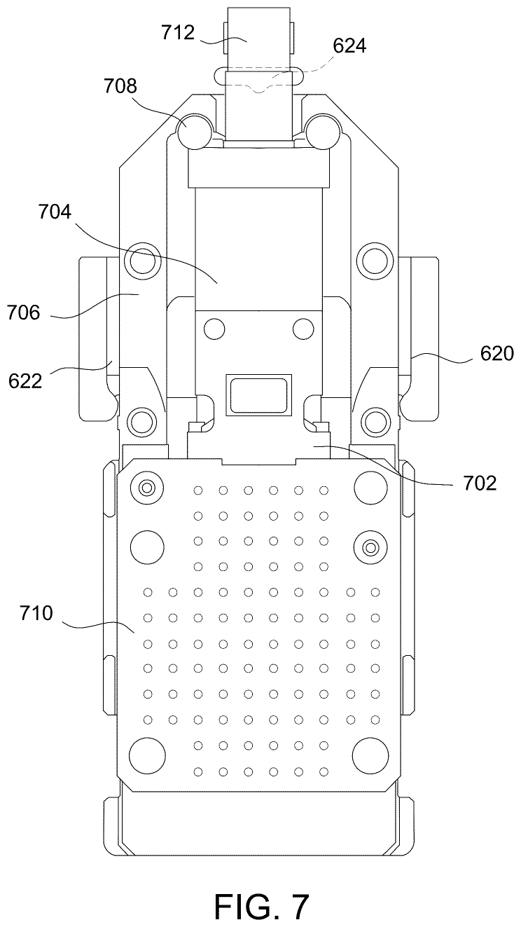

FIG. 7 is a bottom view of a connection between a first MT connector 702 and a second MT connector 704, with a lid 706 (with cord segments 708) positioned on second MT connector 704, and tool 600 positioned on lid 706. As shown in FIG. 7, first, second, and third contact surfaces 620, 622, and 624 each engage lid 706. In this embodiment, first MT connector 702 is included on a transceiver 710, and second MT connector 704 is included on a cable 712.

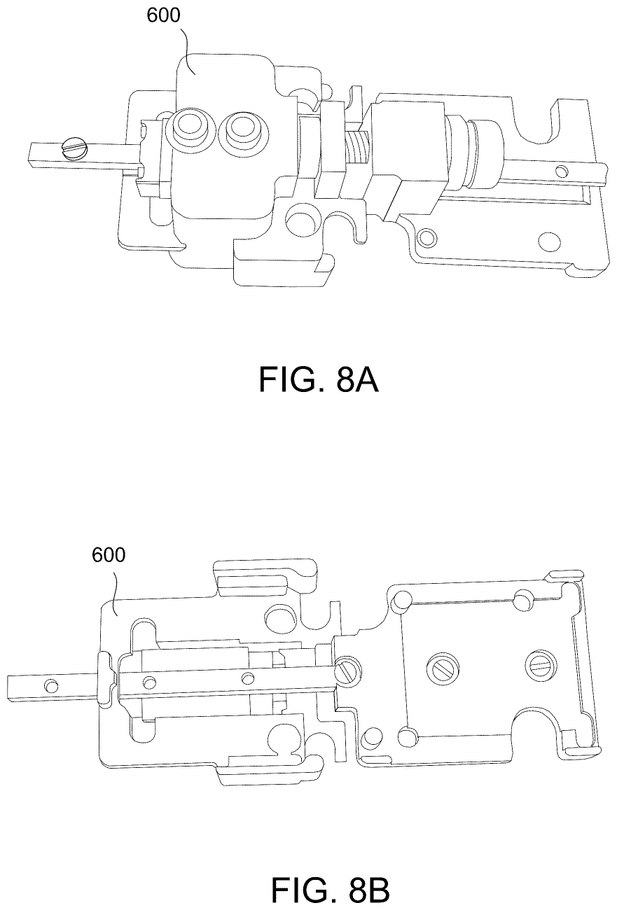

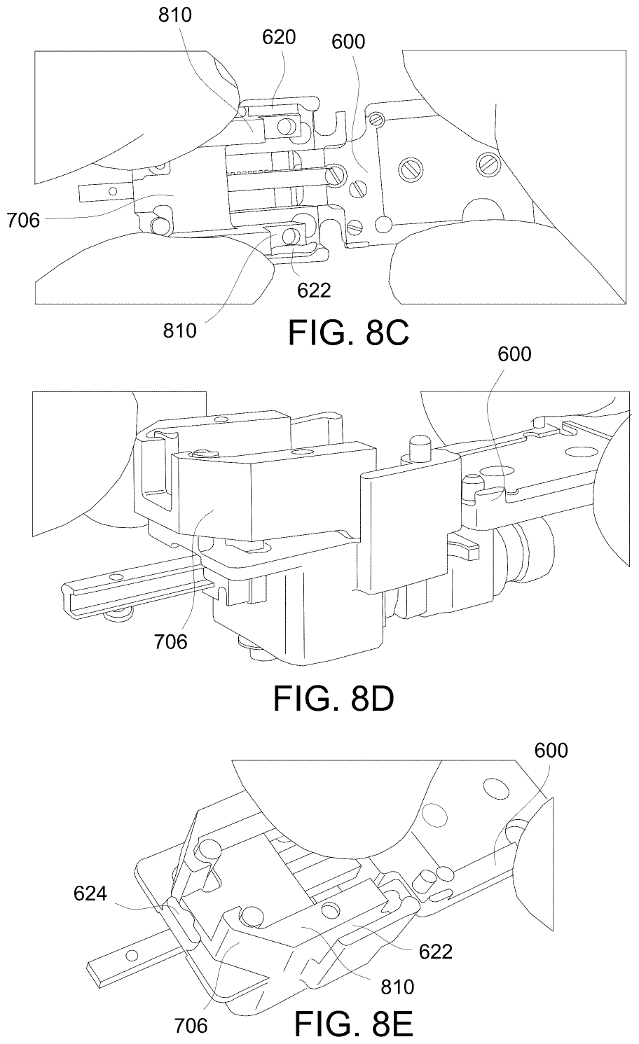

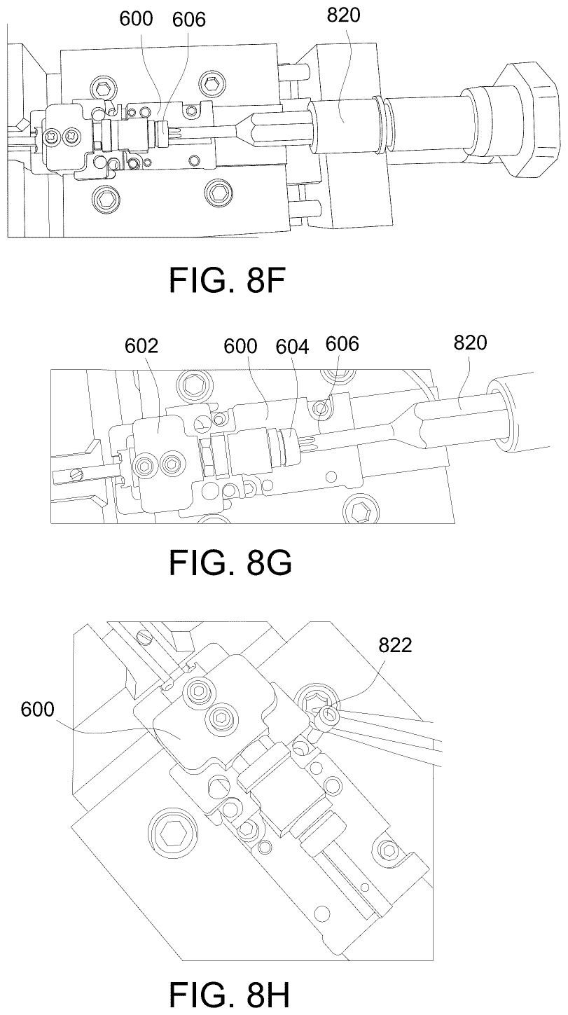

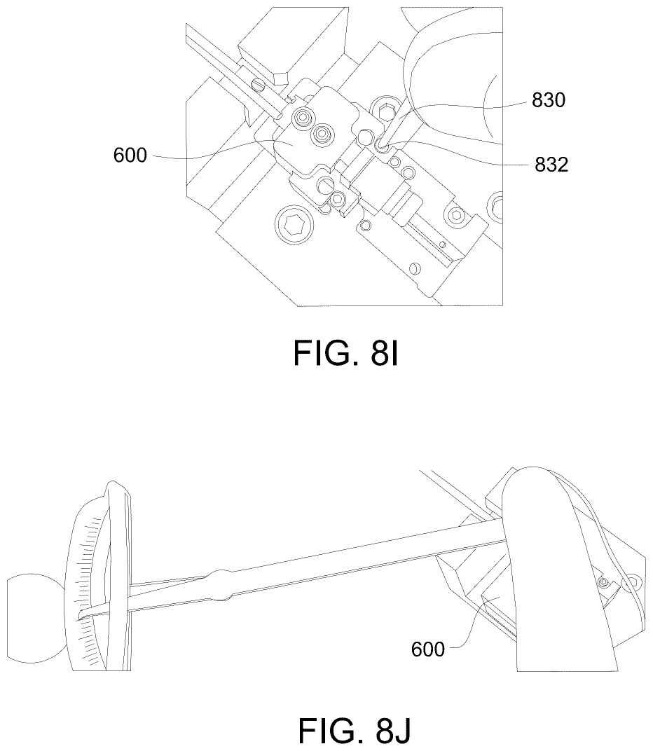

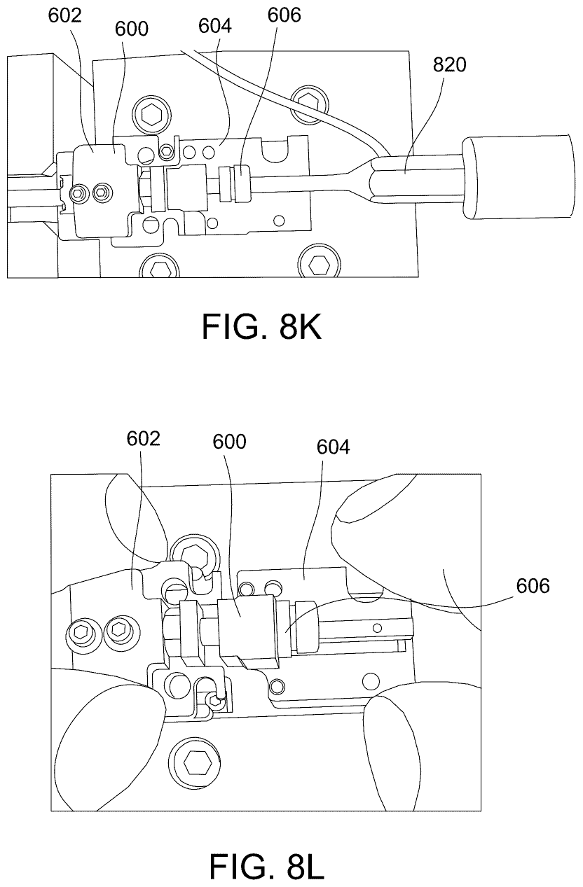

FIGS. 8A-8L illustrate one embodiment of using tool 600 and lid 706 to make and stabilize a connection between first and second MT connectors 702 and 704. Those of skill in the art will appreciate that the process shown in FIGS. 8A-8L is merely an example, and any other suitable steps may be taken to make and stabilize a connection between first and second MT connectors 702 and 704 within the spirit and scope of this disclosure.

As shown in FIGS. 8A and 8B, tool 600 is prepared for use. As shown in FIGS. 8C-8E, lid 706 is inserted into tool 600. Specifically, arms 810 of lid 706 are inserted in between (and in contact with) first and second contact surfaces 620 and 622. Then, lid 706 is pushed forward until lid 706 clears (and subsequently engages) third contact surface 624.

As shown in FIGS. 8F-8H, lid 706 and tool 600 are positioned on transceiver 710 and first and second MT connectors 702 and 704. Specifically, second component 604 of tool 600 is positioned over transceiver 710, and first component 602 of tool 600 and lid 706 are positioned over second MT connector 704. Adjustment mechanism 606 is adjusted (e.g., using a torque-limited screwdriver 820) to move first and second components 602 and 604 of tool 600 towards one another, which results in lid 706 compressing against second MT connector 704. Further, fasteners 822 (e.g., screws) are used (in combination with corresponding apertures) to secure lid 706 to transceiver 710.

As shown in FIGS. 81 and 8J, additional fasteners (e.g., screws) may be inserted to further secure the components. For example, FIG. 8I shows a hex head wrench 830 tightening mounting screws 832 in position through mounting arms into the threaded holes located on transceiver module 710. FIG. 8J shows that mounting screws 832 are torqued to a specific limit to completely secure mounting screws 832. Once this is complete, lid 706 is securely coupled to second MT connector 704 and is sufficiently compressed against second MT connector 704 to facilitate damping vibrations.

As shown in FIGS. 8K and 8L, once lid 706 is securely coupled to second MT connector 704, tool 600 is removed. Further, adjustment mechanism 606 is adjusted (e.g., using torque-limited screwdriver 820) to move first and second components 602 and 604 of tool 600 away from one another, which allows tool 600 to be removed from lid 706.

The embodiments described herein eliminate potential sources of MT connection failure and provide vibration damping at relatively high vibration levels (e.g., vibration levels of at least 28 Gᵣₘₛ, more particularly vibration levels of at least 45 Gᵣₘₛ, and even more particularly vibration levels of at least 60 Gᵣₘₛ). Further, the embodiments described herein provide a “dry” solution that does not require gluing or otherwise fixedly attaching components to one another to mitigate vibrations. Using the embodiments described herein, MT connectors can be de-mated and re-mated relatively easily.

Technical advantages that this disclosure has over at least some known systems include: (1) damping the effects of vibration and serving as a compression spring; (2) maintaining proper forces between the mating interfaces of the module and fiber optic ribbon cable connection; (3) freely aligning MT connectors; 4) eliminating fretting of polished fiber optic mating ends and MT cracking; 5) and damping vibrations at up to 60 Gᵣₘₛ.

The system and methods described herein provide a lid for use with an optical connector. The lid includes a body, and at least one cord segment positioned within the body, wherein the at least one cord segment is configured to contact the optical connector and damp vibrations experienced by the optical connector when the optical connector is positioned within the body.

Example embodiments of methods and systems are described above in detail. The methods and systems are not limited to the specific embodiments described herein, but rather, components of systems and/or steps of the methods may be used independently and separately from other components and/or steps described herein. Accordingly, the example embodiments can be implemented and used in connection with many other applications not specifically described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose various embodiments, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A lid for use with an optical connector, the lid comprising:
a body; and
at least one cord segment positioned within the body, wherein the at least one cord segment is configured to contact the optical connector and damp vibrations experienced by the optical connector when the optical connector is positioned within the body.

2. The lid of claim 1, wherein the body comprises:
a base; and
two arms extending from the base, each arm defining an aperture that facilitates coupling the lid to another component.

3. The lid of claim 2, wherein each aperture has an oblong cross section to accommodate tolerance variations between the lid and the another component.

4. The lid of claim 1, wherein the at least one cord segment comprises a rubber silicone cord segment.

5. The lid of claim 1, wherein the at least one cord segment is configured to deform when compressed against the optical connector.

6. The lid of claim 1, wherein the at least one cord segment is configured to damp vibrations at a level of at least 28 Gᵣₘₛ.

7. The lid of claim 1, wherein the at least one cord segment has a compression force in a range from approximately 5 to 15 Newtons.

8. A connector assembly comprising:
a lid for use with an optical connector and comprising:
a body; and
at least one cord segment positioned within the body, wherein the at least one cord segment is configured to contact the optical connector and damp vibrations experienced by the optical connector when the optical connector is positioned within the body; and
a tool operable to assist in attaching the lid to the optical connector.

9. The connector assembly of claim 8, wherein the tool comprises:
a first component configured to engage the lid;
a second component; and
an adjustment mechanism configured to adjust a relative position of the first and second components.

10. The connector assembly of claim 9, wherein the first component comprises a plurality of contact surfaces sized and oriented to contact the lid.

11. The connector assembly of claim 10, wherein the plurality of contact surfaces comprise a first contact surface, a second contact surface, and a third contact surface.

12. The connector assembly of claim 8, wherein the body of the lid comprises:
a base; and
two arms extending from the base, each arm defining an aperture that facilitates coupling the lid to another component.

13. The connector assembly of claim 12, wherein each aperture has an oblong cross section to accommodate tolerance variations between the lid and the another component.

14. The connector assembly of claim 8, wherein the at least one cord segment comprises a rubber silicone cord segment.

15. The connector assembly of claim 8 wherein the at least one cord segment is configured to deform when compressed against the optical connector.

16. A method of securing a connection between a first optical connector and a second optical connector, the method comprising:
attaching a tool to a lid, the lid including a body and at least one cord segment positioned within the body;
connecting the first optical connector to the second optical connector; and
positioning, using the tool, the lid onto the first optical connector such that the at least one cord segment contacts the optical connector and damps vibrations experienced by the optical connector.

17. The method of claim 16, wherein the tool includes a first component that engages the lid, a second component, and an adjustment mechanism configured to adjust a relative position of the first and second components.

18. The method of claim 17, further comprising manipulating the adjustment mechanism to compress the at least one cord against the first optical connector.

19. The method of claim 18, wherein manipulating the adjustment mechanism comprises manipulating the adjustment mechanism using a screwdriver.

20. The method of claim 16, wherein the at least one cord segment is a rubber silicone cord segment.
